(19) United States
(12) Patent Application Publication
(10) Pub. No.: US 2025/0103015 A1
(43) Pub. Date: Mar. 27, 2025

(54) LABORATORY AUTOMATION USING LABWARE MOVEMENT

(71) Applicant: Keith James McKinley, Brier, WA (US)

(72) Inventor: Keith James McKinley, Brier, WA (US)

(21) Appl. No.: 18/473,851

(22) Filed: Sep. 25, 2023

(51) Int. Cl. G05B 15/02

(52) U.S. Cl. CPC G05B 15/02

(57) ABSTRACT

A system and method for a flexible parallelized system for laboratory automation using labware movement. The parallel laboratory system includes a plurality of independent tools and a plurality of movers. The plurality of movers includes at least one labware item. The plurality of movers is configured to freely operate on a first surface of the parallel laboratory system in a first direction and in a second direction. The plurality of independent tools is configured to independently operate in a third direction. The plurality of independent tools and plurality of movers are controlled by a parallel automation control system. The parallel automation control system includes a controller, a lab automation device, and a user interface. The parallel automation control system commands the plurality of tools and movers to operate in a parallel automation process. An apparatus having the plurality of independent tools, the plurality of movers, and the parallel automation control system is also included.

### BACKGROUND

### Technical Field

The present disclosure relates to a flexibly parallelized system for laboratory automation using labware movement and a method incorporating the same.

### Description of the Related Art

Laboratories around the world have long used various forms of automation to aid in their work and improve productivity. This work varies, often including various organic, inorganic molecules, biological molecules, and biological samples. Such molecules and/or samples are often combined to provide useful mixtures which are used in research, discovery, preclinical, translational, diagnostic, and other clinical applications. Such molecules and/or samples may include primary or cells in culture, simple biochemical or other chemical reactions, clinical or animal samples, or even entire organisms, for example, in the case of some bacteriological, virological, fungal, or even vertebrate research, such as with zebrafish. These activities principally use liquid samples, or samples dissolved or suspended in liquid. Sometimes these are relatively large volumes of fluid, or sometimes may be very small volumes (often down to a microliter and occasionally as low as a picoliter).

A critical step required of most lab automation is to automate the pipetting steps where highly accurate and precise movements of fluid are carried out to move the volume from one vessel to another. These steps often include aliquoting (1-to-many), pooling (many-to-1), and 1-to-1 transfers, with the majority of automated processes requiring a combination of these activities to and from various fluids. Sometimes this work uses pressure or capacitance to detect liquid levels in a vessel or may be based on prescribed heights.

This pipetting is most commonly seen in a few forms, such as in a set of 4 or 8 “fixed” pipettes which typically move in unison along the X, Y, and Z axes, and in varying implementations may move volume independent from each other or may be driven by a shared mechanism to move volumes in unison. Some pipetting may be in the form of an individual pipette or may be in the form of a set of 4, 8, 12, 24, or more “independent pipettes” which are enabled by electromechanical and programmatic utilization to pipette different volumes at different heights, and often at different positions along a common axis. Most often, these independent pipettes are fixed to move in unison in the X-axis, and can move independently along the Y and Z axes (provided they do not crash or attempt to bypass each other in the Y axis) and similar electromechanical and programmatic systems can drive the pipetting action (sometimes referred to as the D axis for “dispense” though it is equally used for aspiration and mixing by alternating aspiration and dispensation) in the D axis.

Another commonly seen form of pipetting is used in a 96-channel head or a 384-channel head, in which 96 channels (usually spaced on a 9 mm grid to match the 8×12 layout of a 96-channel microplate vessel) or 384 channels (usually spaced on a 4.5 mm grid to match the 16×24 layout) can be pipetted in unison. These channels are usually fixed in unison motion in all four axes (including the D axis). Some three-axis instruments place the tooling on multiple axes, which permits motion in the X-axis on two or three semi-independent gantries. Most embodiments have the 96-channel or 384 channel head, the independent pipette, and the gripper on each of three separate gantries. Some three-axis instruments place the tooling primarily on a single axis. Some products offer solutions which automate motion of the labware in a horizontal axis as part of the gantry processes, thus enabling the labware to fit above and below other labware, which allows more labware to fit on a smaller instrument and operate with a similar time frame for the process.

Some systems enable labware motion in the X and Y axes. This may be accomplished with a series of orthogonal gears configured below movers with pyramid-bottomed surfaces or may be accomplished by using small car-like devices. This may be with one or more balls that can be driven in X and Y axes such that the labware is driven along a solid surface beneath the mover. This may be accomplished with other rollers, wheels, or other systems which allow free motion along the plane of motion. These systems would allow the labware to essentially move itself to the location as needed. The critical aspect of these systems is that the labware can bypass other labware in either axis of the horizontal plane.

What is missing, however, is a solution which enables a user to define a laboratory automation process to be carried out by a flexibly parallelized automation system. The focus of this parallel laboratory system is organized by focusing on the activity of each mover, and what further action needs to be taken at each tool. Thus, each separate mover can be individually defined to walk through its process with some steps dependent on other steps (potentially in other movers) being completed before or during the process, and possibly with specific timing in which another step is to be completed at a certain earlier timing. This enables the user to remain focused on the scientific process instead of managing the minutiae of the technical process, while allowing some separate, external actions (e.g., from a third-party robotic gripper) to take place which do not directly pertain to a tool or to a mover. This may be integrated to outside activities such as plate readers, incubators, microscopes, thermocyclers, plate sealers and peelers, colony pickers, general labware storage locations, waste disposal sites, etc.

This combination of the solution preferably permits the user to remain focused on the critical lab activities such that they can more productively define these processes. Traditional automation solutions for uses rely on the prescription of highly rigid processes. While the dynamic opportunities of systems, such as the systems described above, have been conceived for planar material transport to enable more dynamic possibilities, each of these must be carefully orchestrated by the person defining the process. This moves further from the needs of lab automation, as those customers require the processes themselves to be readily defined and redefined with highly dynamic possibilities.

An important selling feature in the existing lab automation market has been easy protocol development and execution, which is generally seen in contrast to the norms in industrial automation which generally prescribe singular or few processes that have very high development efforts and very protracted usage periods, often tied directly to new capital investments to go with the new or adjusted protocols. Lab automation stakeholders require that processes become more dynamically generated, such as by regular scientists with no engineering expertise, but most often by lab automation engineering specialists, at least for the more complex processes.

This leaves a union of the labware motion technology and existing gantry-based lab automation still deficient compared to the true needs of the lab automation industry. The industry needs a cohesive solution where the labware motion table is commoditized to provide true flexible and/or modular solutions for varied tooling to work in parallel and for the method and software system to orchestrate the complex activity with a simplified user experience to equip more efficient protocol development so the simple user experience needs of the lab automation industry can be satisfied while still leveraging the great advantages of the newer planar motion technology.

### BRIEF SUMMARY

Embodiments of a flexible parallelized laboratory process automation system, or parallel laboratory system, and associated methods of operation disclosed herein enable improved capability of parallel laboratory automation through control systems and provide other benefits including increased productivity and ease of use.

The present disclosure relates to laboratory automation systems, for example, a parallelized system for laboratory automation. An embodiment of the parallel laboratory system for laboratory automation may be summarized as including: a first surface; a second surface opposite to the first surface; and a plurality of independent tools extending from the second surface. The parallel laboratory system also includes a plurality of movers that have at least one labware item. The plurality of movers is freely operable on the first surface in a first direction and in a second direction. A parallel control system programmatically commands the plurality of independent tools and the plurality of movers to operate in a parallel process to further define the movement of the at least one labware item.

The parallel laboratory system may include the parallel control system having a controller and a user interface that is in communication with the controller. The user interface of the parallel control system controls the parallel laboratory system such that the parallel control system may be capable of defining an action of the plurality of independent tools. The user interface of the parallel control system may also control the parallel laboratory system so as to define an action of the plurality of movers in conjunction with the plurality of independent tools.

An apparatus of the parallel laboratory system may be summarized as including: a plurality of independent tools; a plurality of movers positioned on a planar surface, the plurality of movers being spaced apart from the independent tools; and a parallel control system electrically coupled to the plurality of independent tools and plurality of movers, the parallel control system configured to operate the independent tools in a parallelized manner in conjunction with the plurality of movers. The plurality of independent tools may be operable by a DC motor, a stepper motor, a servo motor, or a linear magnetic motor. Each type of motor may also include a motion tracking device, for example, an encoder.

The plurality of movers may be configured to operate in a first direction and/or a second direction. The apparatus may further include a an active platform positioned beneath the planar surface. The apparatus may further include one or more orthogonal gears that are positioned partially above the planar surface and within the active platform.

A method for operating a parallel laboratory system for parallel laboratory automation may be summarized as including: determining of a first motion path for a plurality of movers by automated routines along a first direction and a second direction; programmatically ensuring minimization of collisions amongst the plurality of movers, payloads, and other tools or obstructions; programmatically recalculating the first motion paths of the parallel laboratory system to account for a second motion path requested during process execution; coordinating a tooling's first directional motion with the mover's second directional motion to ensure minimum idle time of the mover beneath the tooling while awaiting the tooling's first directional motion. The method may further include the parallel laboratory system planning a z-directional motion descending as a labware element arrives, and ascending as the mover is departing.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 illustrates an embodiment of a parallelized system for laboratory automation, the parallel laboratory system including an apparatus for parallel laboratory automation processes.

FIG. 2 illustrates an alternative embodiment of a parallelized system for laboratory automation.

FIG. 3 illustrates an enlarged view of an example embodiment of an independent tool configuration of FIG. 2.

FIG. 4 illustrates a flow chart representing a method for operating a parallelized system for laboratory automation.

### DETAILED DESCRIPTION

It will be appreciated that, although specific embodiments of the present disclosure are described herein for purposes of illustration, various modifications may be made without departing from the spirit and scope of the present disclosure. Accordingly, the present disclosure is not limited except as by the appended claims.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with laboratory automation process systems have not been shown or described in detail to avoid unnecessarily obscuring descriptions of the embodiments.

Herein, the term “programmatically” refers to a process system output defined by a set of instructions from a computer program or code. Unless the context requires otherwise, throughout the specification and claims that follow, the word “comprise” and variations thereof, such as “comprises” and “comprising” are to be construed in an open, inclusive sense, that is, as “including, but not limited to.” Described herein, “parallel” operations refer to automation software and/or hardware that allows a user to process multiple outputs concurrently. For example, parallel activities with separate tools allows for the ability to orchestrate separate activities by separate gantries. Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the features, structures, or characteristics may be combined in any suitable manner in one or more aspects of the present disclosure. The term “mover” and “puck” are interchangeable and refer to the same feature and/or reference numeral. The term “lab” and “laboratory” are interchangeable and refer to the same feature and/or reference numeral.

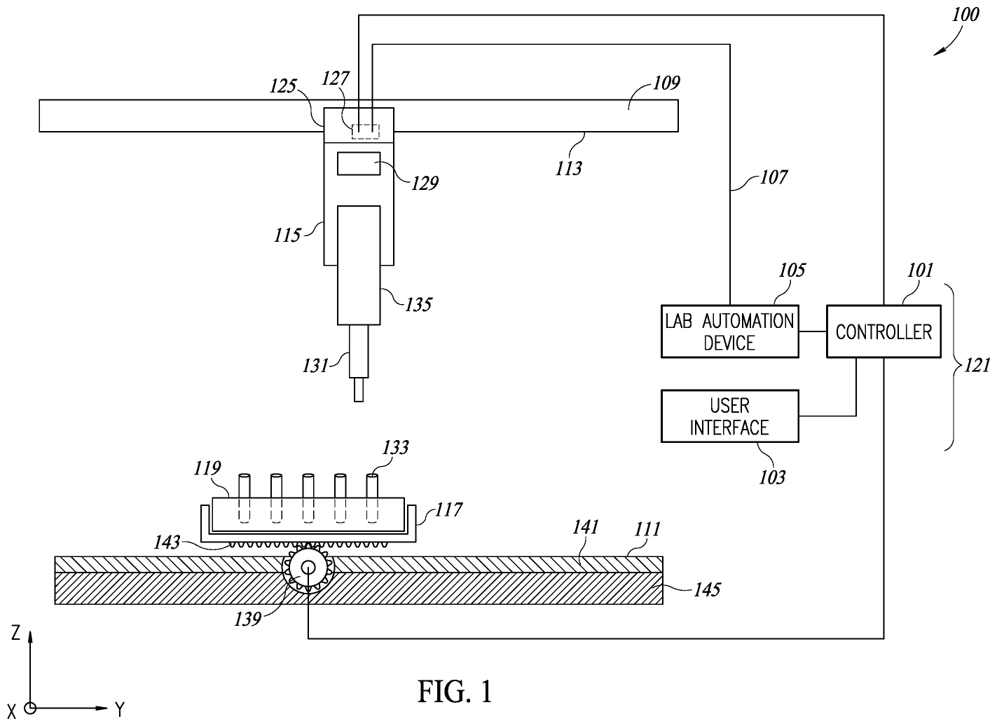

FIG. 1 illustrates a parallelized system for laboratory automation or parallel laboratory system 100 for labware movement according to one example embodiment. The parallel laboratory system 100 is modular in the platform itself, thus providing the planar labware motion. The parallel laboratory system 100 comes in discrete options which are matable to each other in order to allow a customer to install solutions of varying sizes or options that may enable the customer the ability to expand the parallel laboratory system 100 from one embodiment to another embodiment, by the addition and/or removal of modules. Integrating the parallel laboratory system 100 described herein to run a parallel laboratory automation process encompasses the practice of executing multiple automation tasks concurrently. A parallel laboratory automation process can increase production times and make more efficient use of laboratory automation equipment and instruments.

The parallel laboratory system 100 includes one or more movers 117 positioned over a first surface or planar surface 111. A frame 109 having a second surface 113 is positioned in the parallel laboratory system 100, the second surface 113 being opposite to the planar surface 111. One or more independent tools 115 extend from or are proximal to the second surface 113 of the frame 109 towards the planar surface 111. The parallel laboratory system 100 further includes a controller 101, a lab automation effector or device 105 with a lab automation tubing member 107, and a user interface 103, which together collectively forms a parallel automation control system 121. The lab automation device 105 dispenses sufficient liquid volume via the lab automation tubing member 107 based on input from the parallel automation control system 121. However, in some embodiments, the lab automation tubing member 107 may be dispenser tubing, wiring to manage the motion of the independent pipettes, electronic wiring to drive a 96-channel head's D-axis, or other tubing member that depends upon the function of each individual tool. The parallel automation control system 121 is communicatively coupled to the one or more independent tools 115 and one or more movers 117 within the parallel laboratory system 100, such that each movement from the one or more independent tools 115 and one or more movers 117 are in unison with each other.

The plurality of independent tools 115 extending from the frame 109 are only operable on one independent axis, for example, as illustrated in the embodiment of FIG. 1, in a third directional axis Z. The one or more independent tools 115 may be tooling such as a dispenser, washer, pipette, seal piercing, tube capping, pin tools, cameras for visual inspection and barcode scanning, or grippers to move labware. For example, as illustrated in FIG. 1, the independent tool 115 is configured as a pipetting gantry. In some embodiments, each independent tool 115 includes a tool head 135 that may include one or more pipettors 131. The plurality of independent tools 115 are each driven by a motor 129. The motor 129 may be a DC motor, stepper motor, servo motor, linear magnetic motor, a rack and pinon, worm drive, peristaltic, or other motorized configurations capable of controlling movement of the independent tool 115. The independent tools 115 may also incorporate encoders or other similar motion tracking technologies that have the capability to communicate with the parallel automation control system 121.

The parallel laboratory system 100 further includes a carrier device 125 having a carrier motor 127. The carrier device 125 is coupled to the independent tools 115 and housed within the frame 109. The carrier device 125 allows free movement amongst the plurality of independent tools 115 to create a parallel laboratory system 100 capable of parallel laboratory automation. The carrier device 125 is in continuous communication with the parallel automation control system 121, consistently adding input to the laboratory automation process.

The plurality of movers 117 are positioned adjacent to the planar surface 111, opposite from the position of the independent tools 115 on the second surface 113. The movers 117 may operate in either a first direction X, a second direction Y, or a combination thereof and designed to be used in conjunction with the third directional axis Z of the independent tools 115. The first and second directions X, Y are operable on a horizontal plane. The third directional axis Z is operable on a vertical axis. The plurality of movers 117 may be configured as a tray, rack holder, or other types of containers capable of holding or containing laboratory items or materials. The plurality of movers 117 may operate in a wide range of motion paths to ensure each independent mover 117 arrives at its designated station at its designated time.

The plurality of movers 117 may include a plurality of bearings 143 that contribute to the free-range movement of the movers 117 across the planar surface 111 in the parallel laboratory system 100. The plurality of bearings 143 on the bottom of the movers 117 function in a passive manner and operate in conjunction with a movement device 139 housed within an active platform 141 partially arranged beneath the planar surface 111 but on, or above, a subsurface 145. For example, as illustrated in FIG. 1, the movement device 139 (i.e., an orthogonal gear, friction-bound wheels, or roller bearings or balls) is superposed within the active platform 141 and the subsurface 145 and drives motion against the bearings 143 of the movers 117 creating continuous motion on the planar surface 111. The unique capability for the plurality of movers 117 to move in the first direction X and the second direction Y, in conjunction with movement in the third directional axis Z of the independent tools 115 via input from the parallel automation control system 121, advantageously improves production process times and enables simple user experience. Each mover 117 may also include a container 119 having at least one labware item 133. The labware items 133 may be beakers, test tubes, funnels, cylinders, flasks, burettes, pipettes, or other similar types of labware items conventionally used in laboratory automaton systems.

The parallel automation control system 121 permits the user to define actions taken by the parallel laboratory system 100 organized by the order of actions taken on each element or feature within the parallel laboratory system 100, such as the independent tools 115 and movers 117. The independent tools 115 and movers 117 are communicatively coupled to the controller 101 and configured and/or operable to move in a manner defined by the user. The controller 101 may be a computer or other system capable of accepting input, storing data, retrieving said data, and/or processing and outputting information. The parallel automation control system 121 described herein permits dynamic and parallel process development by a user to define an arbitrary process for each mover 117 and/or labware item 133 in the parallel laboratory system 100.

In at least one embodiment, the parallel automation control system 121 is organized by focusing on the activity of each mover 117, and what specific action needs to be taken in sequence and at each independent tool 115. This specific action may be requested by the user (not shown) via the user interface 103 of the parallel automation control system 121. Thus, each mover 117 may be individually defined to walk through its process with at least some steps dependent on other steps (potentially in other movers) being completed before or during the process. This may also be possible with specific timing that another step was completed within a certain earlier range of time. Doing so enables the user to remain focused on the scientific process instead of managing certain unnecessary aspects of the process because the parallel automation control system 121 possesses the capability to completely manage the technical aspects of the laboratory automation process that transpires in the background of the process. The parallel automation control system 121 allows the labware items 133 to move to a desired location, essentially independently within the system. The labware items 133 are therefore capable of bypassing other labware in either the first direction X or the second direction Y on the horizontal plane, enabling true parallelism in the laboratory process automation system.

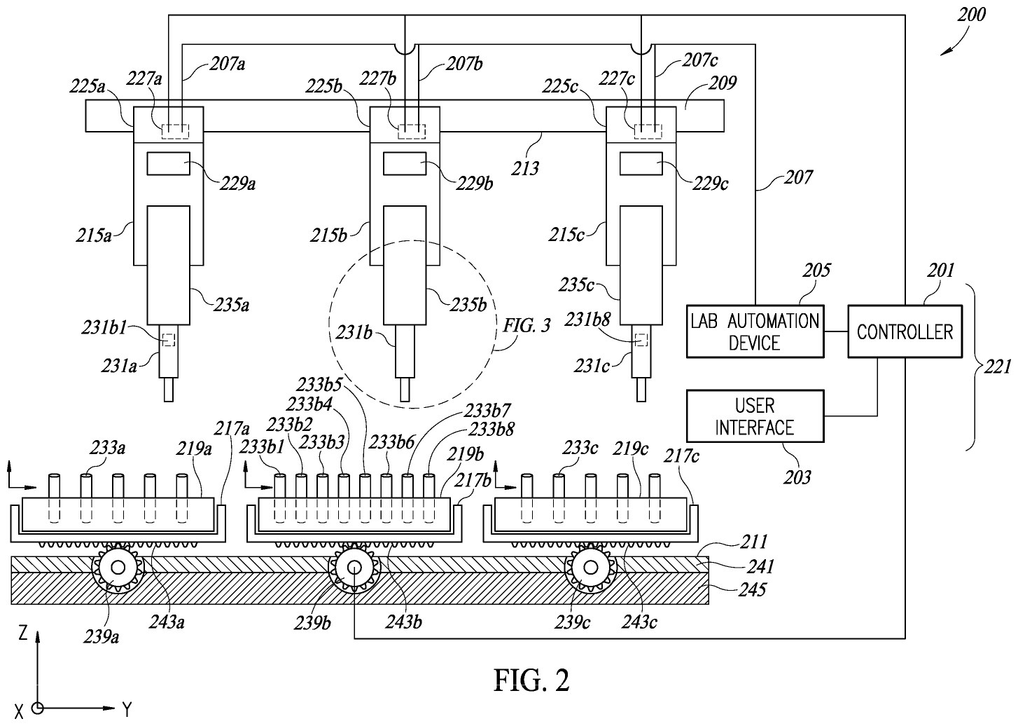

FIG. 2 illustrates an alternative embodiment of a parallel laboratory system 200. The example embodiment of FIG. 2 demonstrates the variability of the parallel laboratory system 200 that can be utilized by the user, such that the number of movers and tools represented in the embodiment are for example purposes and may be any number of movers and/or tools.

In this embodiment, the parallel laboratory system 200 is similar to the embodiment of the parallel laboratory system 100 described in FIG. 1 with certain variations. In this example embodiment of the parallel laboratory system 200, a plurality of movers 217a, 217b, 217c are positioned over a first surface or planar surface 211. A frame 209 having a second surface 213 is positioned opposite to the planar surface 211. The parallel laboratory system 200 further includes a plurality of independent tools 215a, 215b, 215c that extend from the second surface 213. In some embodiments, such as the example embodiment shown in FIG. 1, the plurality of independent tools work in conjunction with a controller 201, a lab automation device 205 having a lab automation tubing member 207, and a user interface 203 that collectively forms a parallel automation control system 221. However, some embodiments may include alternatives to the lab automation device 205. For example, devices that were listed above in connection with the lab automation tubing member 107 include devices that are capable of aspiration and dispensing of liquids, or other devices that are conventionally utilized in a laboratory automation setting. The independent tools 215a, 215b, 215c may independently operate in the third directional axis Z in the vertical axis via input from the parallel automation control system 221. An advantage of the example embodiment of the parallel laboratory system 200 is the ability for each independent tool 215a, 215b, 215c to operate in an independent manner in sequence with the plurality of movers 217a, 217b, 217c, thus providing the capability of the movers to travel around and/or bypass each other to reach each tool in any order regardless of the other mover's process and position. Additionally, each mover possesses the capability to complete these bypass movements without direct interference or supervision from the user.

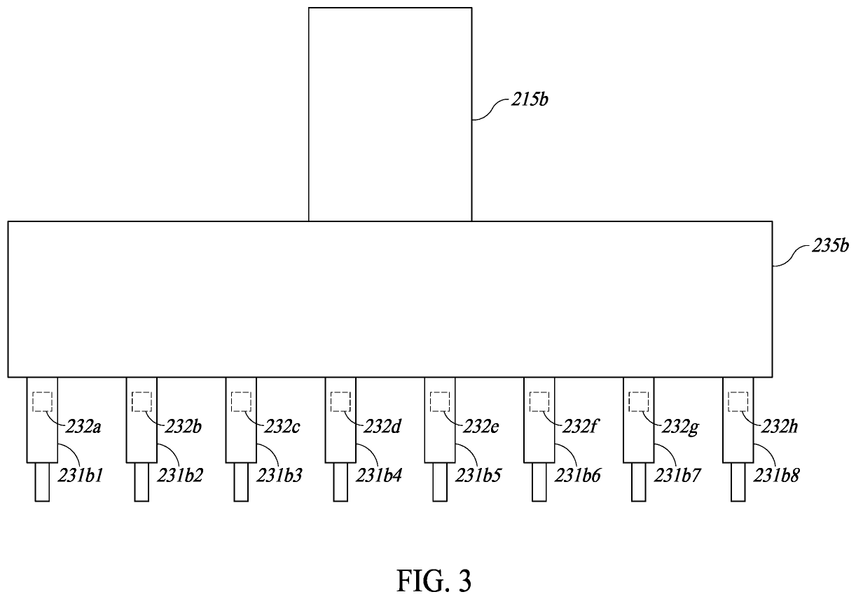

In FIG. 2, the plurality of independent tools 215a, 215b, 215c are each on an independent axis, and may include more or fewer tooling as required by the user. The plurality of independent tools 215a, 215b, 215c each include a respective motor 229a, 229b, 229c for independent operation via communication with the parallel automation control system 221. Each independent tool 215a, 215b, 215c may include a tool head 235a, 235b, 235c and/or one or more tools previously mentioned above, such as for example, pipettes 231a, 231b, 231c, as demonstrated in FIG. 3. Each independent tool 215a, 215b, 215c may also include a carrier device 225a, 225b, 225c having a carrier motor 227a, 227b, 227c that precisely correlates to the movement of the plurality of movers 217a, 217b, 217c.

Similar to the motion paths of the movers described previously in FIG. 1, in this example embodiment of the parallel laboratory system 200, the plurality of movers 217a, 217b, 217c are configured to freely move about the planar surface 211 in the first direction X, the second direction Y, or a combination thereof. A benefit of the parallel laboratory system 200 is that the collection of movers 217a, 217b, 217c are capable of a wide range of motion paths, each mover determined by automated routines to ensure no mover, or its payload collides with any other mover, payload, tool, or other obstruction, regardless of the number of movers in the parallel laboratory system 200. In some embodiments, each of the plurality of movers 217 may include bearings 243a, 243b, 243c on the bottom of the movers 217a, 217b, 217c that function in a passive manner and operate in conjunction with one or more movement devices 239a, 239b, 239c (i.e., orthogonal gears) superposed within a subsurface 245 and an active platform 241. The movement devices 239a, 239b, 239c drives motion against the bearings 243a, 243b, 243c of the movers 217a, 217b, 217c and creates continuous motion on the planar surface 211. The movement devices 239a, 239b, 239c may be orthogonal gears, or various types of friction-bound wheels, roller bearings, or balls that contribute to the movement of the movers 217a, 217b, 217c on the planar surface 211.

A container or microplate 219a, 219b, 219c having at least one labware item 233 is housed within each respective mover 217a, 217b, 217c. Alternatively, in some embodiments, the microplate 219a, 219b, 219c is the labware item itself and may include molded wells instead of separate tubes. The plurality of movers 217a, 217b, 217c move about the planar surface 211 in an orchestrated manner without the interference or adherence from a user to manipulate specific motions. Even with an increased number of movers and/or tools, the parallel laboratory system 200 permits the user to define the actions for each independent tool 215a, 215b, 215c to operate in the third directional axis Z and for the movers 217a, 217b, 217c to operate in the first and second directions X, Y via the parallel automation control system 221.

As shown in FIG. 2, the parallel laboratory system 200 and process described herein permits a variety of parallelized laboratory automation activities since many movers may be in motion concurrently. As noted above, parallel automation control system 221 is in continuous communication with the laboratory components such that the movement of any one mover 217a, 217b, 217c to its exact destination is accommodated at the time it is needed. The user is thus enabled to define the overall process needed to be carried out on each labware item 233a, 233b, 233c, regardless of any particular mover motion needs, and trust that the solution for mover movement will be carried out. Additionally, in the event no solution is possible, this will be communicated via the parallel automation control system 221 to the user at the earliest possible moment. Any motion interruptions during processing, such as delayed activity by a particular tool, user, or other constraint, should be accommodated by automated redetermination of the motion needed.

The user also possesses the capability to define a particular labware item 233a, 233b, 233c that may be presented to the user for manual interaction, which may be delayed arbitrarily and the parallel laboratory system 200 will be able to accommodate this variation. The user may have the capability to define a particular labware item 233a, 233b, 233c that should be presented to other instrumentation for automated interaction which may also be delayed arbitrarily.

FIG. 3 demonstrates an enlarged section of the tool head 235b and independent pipette 231bconfiguration of FIG. 2, according to an example embodiment. For example, in FIG. 3 each independent pipette 231b1-231b8 on the tool head 235b has a secondary motor 232a -232h, respectively. Each individual pipette 231b1-231b8 may be mirrored by an individual labware item 233b1-233b8, which contributes to the independent electromechanical and programmatic utilization of each individual pipette 231B1-231B8 to operate at different volumes at different heights, and often at different positions along a common axis, independently, as illustrated in this particular configuration shown in FIG. 3.

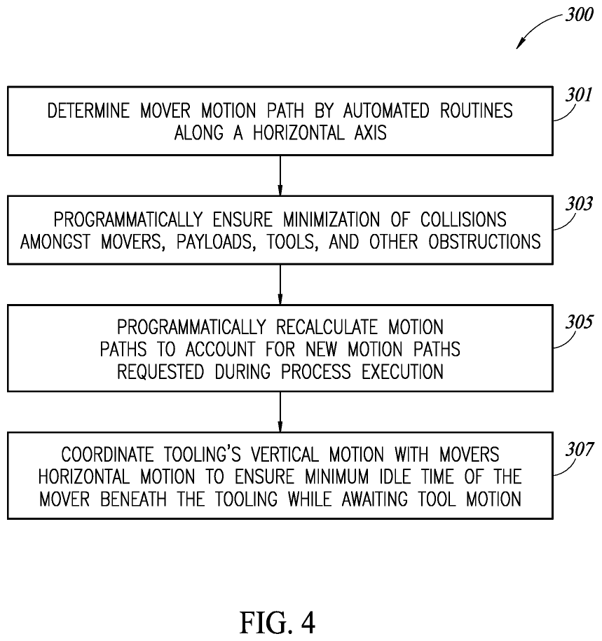

FIG. 4 shows an example flow diagram 300 illustrating steps associated with operating the parallel laboratory systems described herein, e.g., parallel laboratory system 100, for laboratory automation using labware movement as described above. A first process step 301 of the flow diagram 300 includes an initial step for utilizing an array of automated tooling to determine the motion path of the one or more of movers and the one or more independent tools by automated routines along the vertical axis and/or the horizontal axes. The user via the user interface of the parallel automation control system enables the user to arrange the proposed activity of each independent tool and each independent mover. For example, for the first process step 301, each separate mover can be individually defined to maneuver through the designated process with some steps dependent on other steps being completed before or during the movers specific timing.

In the first process step 301, allowing the user to initially determine the activities of the process may include the initiation or preparation of priming a pump or loading disposable tips. Furthermore, allowing the user to readily define the activities of the process may also include operational steps such as aspirating and dispensing with a pipette, capturing an image with a camera, sampling a colony with a colony picker, or any other routine function of tooling included in a conventional laboratory automation process.

In a second process step 303 of the flow diagram 300, the parallel laboratory system 100 will programmatically ensure that no mover or its payload collides with any other mover, payload, tool, or other obstruction. The mover motion paths are determined by automated routines via the parallel automation control system that enable free motion of the movers. Thus, the critical aspect of the second process step 303 is that the movers possess the ability to bypass other movers along the horizontal axes and maneuver to their designated location as needed.

While avoiding collisions or obstructions in the second process step 303, a third process step 305 represents a phase in the process where the motion paths of the movers are readily and consistently recalculated by the parallel automation control system 121 with sufficient frequency to account for the new motion paths requested during process execution.

In a fourth process step 307, the vertical motion of the tooling can be coordinated with the mover's horizontal motion to ensure the minimum idle time of the mover beneath the tooling while awaiting tool motion, which is primarily achieved by planning motion in the third directional axis Z (e.g., the tooling) descending as the labware item arrives and/or ascending as the mover is departing. As described above, the fourth process step 307 may allow the user to readily define activities in this step that may include wrap-up activities such as purging a pump, disposing of disposable tips, or other conclusionary activities.

Aspects of the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled.

1. A flexible parallelized system for laboratory automation, comprising:
a first surface;
a second surface opposite to the first surface;
a plurality of movers having at least one labware item, the plurality of movers freely operable on the first surface in a first direction and in a second direction;
a plurality of independent tools extending from the second surface and independently operable in a third direction; and
a parallel automation control system communicatively coupled to the plurality of independent tools and the plurality of movers to operate in a parallel laboratory automation process to define movement of the at least one labware item.

2. The system of claim 1, wherein the first and second directions are on a horizontal axis, and the third direction is on a vertical axis.

3. The system of claim 1, wherein the parallel automation control system comprises a controller.

4. The system of claim 3, wherein the parallel automation control system comprises a user interface in communication with the controller.

5. The system of claim 4, wherein the user interface of the parallel automation control system controls the parallel laboratory automation process of the system such that the parallel automation control system can define an independent action of the plurality of independent tools.

6. The system of claim 4, wherein the user interface of the parallel automation control system controls the parallel laboratory automation process of the system to define an action of the plurality of movers in sequence with the plurality of independent tools.

7. The system of claim 1, further comprising a lab automation device coupled to the plurality of independent tools wherein the lab automation device aspirates, dispenses, mixes, or manipulates liquid volume based on input from the parallel automation control system.

8. The system of claim 1, wherein the flexible parallelized system for laboratory automation is a modular system that includes a modular control system.

9. An apparatus, comprising:
a plurality of independent tools;
a plurality of movers positioned on a planar surface, the plurality of movers spaced apart from the independent tools; and
a parallel automation control system communicatively coupled to the plurality of independent tools and plurality of movers, wherein the parallel automation control system is configured to operate the independent tools in a parallelized manner in conjunction with the plurality of movers.

10. The apparatus of claim 9, wherein the plurality of independent tools is operable by at least one of a DC motor, a stepper motor, a servo motor, or a linear magnetic motor.

11. The apparatus of claim 10, wherein the motor comprises an encoder or motion tracking device.

12. The apparatus of claim 9, wherein the plurality of independent tools is operable in a third direction.

13. The apparatus of claim 9, wherein the plurality of movers is configured to operate in a first direction and a second direction.

14. The apparatus of claim 9, further comprising an active platform, the active platform having a movement device partially positioned beneath the planar surface and within the active platform.

15. The apparatus of claim 14, wherein the movement device is one or more orthogonal gears positioned within the active platform.

16. The apparatus of claim 14, wherein the plurality of movers is freely operable against the active platform.

17. A method for operating a flexible parallelized system for laboratory automation, comprising:
determining a first motion path for a plurality of movers by automated routines along a first direction and a second direction;
programmatically controlling movement to prevent collisions amongst movers, payloads, and other tools or obstructions;
programmatically recalculating the first motion path to account for a second motion path requested during process execution; and
coordinating a first directional movement with a second directional movement to ensure minimum idle time of the mover beneath a tooling while awaiting the first directional movement.

18. The method of claim 17, further comprising the flexible parallelized system planning a z-directional movement of the tooling descending as a labware element arrives, and the tooling ascending as the mover is departing.

19. The method of claim 17, further comprising a parallel automation control system, wherein the parallel automation control system includes a controller, a user interface, and a lab automation device.

20. The method of claim 19, wherein the parallel automation control system is communicatively coupled to the mover and the tooling.
